(19) United States
(12) Patent Application Publication
(10) Pub. No.: US 2025/0337565 A1
(43) Pub. Date: Oct. 30, 2025

(54) INFORMATION PROCESSING APPARATUS AND INFORMATION PROCESSING APPARATUS ACTIVATION METHOD

(71) Applicant: Hitachi Vantara, Ltd., Yokohama (JP)

(72) Inventors: Takeo OKAMURA, Yokohama (JP); Yusuke YAMAMOTO, Yokohama (JP)

(21) Appl. No.: 18/824,012

(22) Filed: Sep. 4, 2024

(30) Foreign Application Priority Data
Apr. 25, 2024 (JP) 2024-071214

(51) Int. Cl. H04L 9/08; H04L 9/32

(52) U.S. Cl. CPC H04L 9/0825; H04L 9/3247

(57) ABSTRACT

It is made possible to activate an information processing apparatus easily and appropriately when verification of a software image at the time of activation of the information processing apparatus is unsuccessful. Provided is an information processing apparatus including controllers each of which includes a CPU, an FPGA, and SPI ROMs, and configured such that one SPI ROM stores an SPI ROM image, another SPI ROM stores an e-signature and public key, and each of FPGAs of the respective controllers acquires the e-signature and public key at the time of activation of the information processing apparatus and verifies whether or not the SPI ROM image is falsified, and the FPGA of the controller, which detects presence of falsification, acquires an SPI ROM image via the FPGA of the controller having a software image that is detected as being not falsified, and causes an operation by the CPU to be started.

### CROSS REFERENCE TO RELATED APPLICATION

This application claims priority to Japanese Patent Application No. 2024-071214, filed Apr. 25, 2024, the contents of which are incorporated herein by reference in its entirety for all purposes.

### BACKGROUND OF THE INVENTION

### 1. Field of the Invention

The present invention relates to a technology to securely activate an information processing apparatus.

### 2. Description of the Related Art

As a technology to securely activate an information processing apparatus, there has been conventionally known secure booting in which presence or absence of falsification of the firmware or the like is verified, and when absence of falsification can be verified, an information processing apparatus is activated. For example, where a falsification of the firmware is detected, and secure booting is unsuccessful, the activation of the information processing apparatus is disabled. When secure booting is unsuccessful in this manner, apparatus replacement of the information processing apparatus or recovery operation using a special jig or the like become necessary, resulting in requiring a long time for the information processing apparatus to be recovered.

Regarding this, U.S. Pat. No. 10,740,468 discloses a technology in which, in a computer system including a first controller and a second controller, the first controller is caused to write a firmware image in the second controller, and the security of the written firmware image can be verified.

### SUMMARY OF THE INVENTION

In the technology disclosed in U.S. Pat. No. 10,740,468, since the first controller writes firmware in the second controller, and the security of the firmware is verified, a load is applied to the first controller side.

In addition, a configuration for access from the first controller to the second controller needs to be prepared in advance.

The present invention has been made in view of the circumstance described above, and an object of the present invention is to provide a technology that makes it possible to activate an information processing apparatus easily and appropriately when verification of a software image at the time of activation of the information processing apparatus is unsuccessful.

In order to achieve the object described above, an information processing apparatus according to an aspect is an information processing apparatus having a plurality of control apparatuses each of which includes a processor, a processing circuit, a first storage apparatus, and a second storage apparatus, the second storage apparatus storing a software image to be executed by the processor, the first storage apparatus storing an e-signature and a public key for verifying whether or not the software image is falsified. Further, the processing circuit of each of the control apparatuses acquires the e-signature and the public key from the first storage apparatus at a time of activation of the information processing apparatus, and verifies whether or not the software image stored on the second storage apparatus is falsified. Furthermore, a first processing circuit of a first control apparatus, the first processing circuit detecting that the software image is falsified, acquires a software image via a second processing circuit of a second control apparatus having the software image that is detected as being not falsified, and causes an operation by the processor of the first control apparatus to be started using the acquired software image.

According to the present invention, it is possible to activate an information processing apparatus easily and appropriately when verification of a software image at the time of activation of the information processing apparatus is unsuccessful.

### BRIEF DESCRIPTION OF THE DRAWINGS

FIG. 1 is an overall configuration diagram of an information processing apparatus according to one embodiment;

FIG. 2 is a figure for explaining a secure booting state table according to the one embodiment;

FIG. 3 is a figure for explaining an FPGA-to-FPGA connection state table according to the one embodiment;

FIG. 4 is a figure for explaining a recovery history table according to the one embodiment;

FIG. 5 is a configuration diagram of a recovery management table according to the one embodiment;

FIG. 6 is a first operation transition diagram of an activation process according to the one embodiment;

FIG. 7 is a second operation transition diagram of the activation process according to the one embodiment; and

FIG. 8 is a flowchart of the activation process according to the one embodiment.

### DESCRIPTION OF THE PREFERRED EMBODIMENTS

An embodiment is explained with reference to the figures. Note that the embodiment explained below does not limit the invention according to claims, and not all elements explained in the embodiment and combinations thereof are not necessarily essential to the solution of the invention.

Whereas information is explained using the expression “AAA table” in some cases in the following explanation, information may be expressed by any data structure. That is, in order to indicate that the information does not depend on its data structure, the “AAA table” can be called “AAA information.”

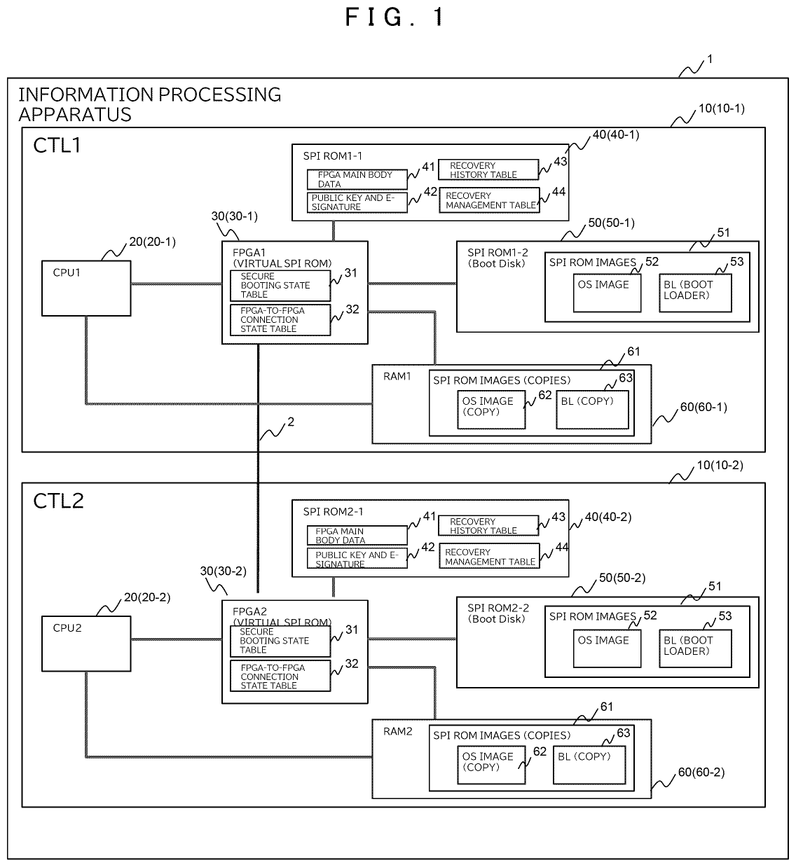

FIG. 1 is an overall configuration diagram of an information processing apparatus according to one embodiment.

For example, an information processing apparatus 1 is a storage apparatus, a general-purpose computer (computer), or the like, and includes a plurality of controllers 10. The controllers 10 include a first controller 10-1 (also referred to as a CTL 1) and a second controller 10-2 (also referred to as a CTL 2). Here, where the first controller 10-1 is an example of the first control apparatus, the second controller 10-2 is an example of the second control apparatus. Where the first controller 10-1 is an example of the second control apparatus, the second controller 10-2 is an example of the first control apparatus.

Each of the controllers 10 (10-1, 10-2) includes: a CPU 20 (20-1, 20-2) as an example of the processor; a field programmable gate array (FPGA) 30 (30-1, 30-2) as an example of the processing circuit; a serial peripheral interface (SPI) read only memory (ROM) 40 (40-1, 40-2) as an example of the first storage apparatus; an SPI ROM 50 (50-1, 50-2) as an example of the second storage apparatus; and a random access memory (RAM) 60 (60-1, 60-2). The FPGA 30-1 and the FPGA 30-2 are connected via a signal line 2. Here, where the FPGA 30-1 is an example of the first processing circuit, the FPGA 30-2 is an example of the second processing circuit. Where the FPGA 30-1 is an example of the second processing circuit, the FPGA 30-2 is an example of the first processing circuit.

Here, as depicted in FIG. 1, the CPU 20-1 is referred to as a CPU 1, the CPU 20-2 is referred to as a CPU 2, the FPGA 30-1 is referred to as an FPGA 1, the FPGA 30-2 is referred to as an FPGA 2, the SPI ROM 40-1 is referred to as an SPI ROM 1-1, the SPI ROM 40-2 is referred to as an SPI ROM 2-1, the SPI ROM 50-1 is referred to as an SPI ROM 1-2, the SPI ROM 50-2 is referred to as an SPI ROM 2-2, the RAM 60-1 is referred to as a RAM 1, and the RAM 60-2 is referred to as a RAM 2, in some cases.

For example, the SPI ROM 40 is a flash ROM, and stores various types of data to be used in the FPGA 30. In the present embodiment, the SPI ROM 40 stores FPGA main body data 41, a public key and e-signature 42, a recovery history table 43, and a recovery management table 44. The FPGA main body data 41 is data for construction of a circuit in the FPGA 30 by the FPGA 30.

For example, the SPI ROM 50 is a flash ROM, and stores data such as a program to be used by the CPU 20. In the present embodiment, the SPI ROM 50 stores SPI ROM images 51 as an example of the software images. The SPI ROM images 51 include an operating system (OS) image 52 and a boot loader (BL) 53.

For example, the RAM 60 is a double-data-rate synchronous dynamic RAM (DDR SDRAM). The RAM 60 stores data to be used by the FPGA 30, a software image to be executed by the CPU 20, and the like. In the present embodiment, the RAM 60 stores SPI ROM images 61 (OS image 62, BL 63) which are copies of the SPI ROM images 51 of the SPI ROM 50.

Using data read out from the SPI ROM 50 to the RAM 60 such as the SPI ROM images 61 including the OS image 62 and the BL 63, the CPU 20 controls an activation process of the information processing apparatus 1 and its hardware after the activation. In the present embodiment, the CPU 20 is not allowed to access the storage area of the SPI ROM images 51 of the SPI ROM 50 of another controller 10.

The FPGA 30 reads out the FPGA main body data 41 from the SPI ROM 40, constructs a circuit to execute predetermined processes, and causes the constructed circuit to execute various types of processes such as an activation process. The FPGA 30 stores a secure booting state table 31 and an FPGA-to-FPGA connection state table 32.

Next, the secure booting state table 31 is explained.

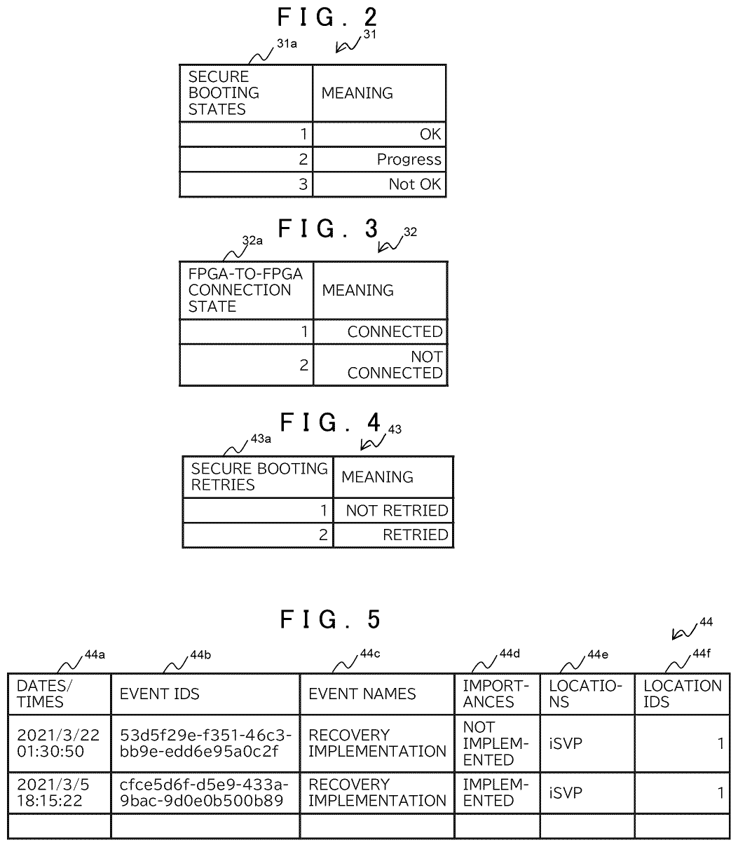

FIG. 2 is a figure for explaining the secure booting state table according to the one embodiment.

The secure booting state table 31 includes fields of secure booting states 31a. The secure booting states 31a store information representing states of secure booting in an activation process. In the present embodiment, any of “1” representing that secure booting is successful (OK), “2” representing that secure booting is in progress (Progress), and “3” representing that secure booting is unsuccessful (Not OK) is stored in the secure booting states 31a.

Next, the FPGA-to-FPGA connection state table 32 is explained.

FIG. 3 is a figure for explaining the FPGA-to-FPGA connection state table according to the one embodiment.

The FPGA-to-FPGA connection state table 32 includes fields of FPGA-to-FPGA connection states 32a. The FPGA-to-FPGA connection states 32a store information representing whether or not communication with the FPGA 30 of another controller 10 is enabled. In the present embodiment, any of “1” representing that communication with the FPGA is enabled (connected), and “2” representing that communication with the FPGA is not enabled (not connected) is stored in the FPGA-to-FPGA connection states 32a. Here, the FPGA 30 regularly makes an inquiry as to whether or not communication with the FPGA 30 of the other controller 10 connected via the signal line 2 is enabled, and stores, in an FPGA-to-FPGA connection state 32a, information corresponding to a result thereof.

Next, the recovery history table 43 is explained.

FIG. 4 is a figure for explaining the recovery history table according to the one embodiment.

The recovery history table 43 includes fields of secure booting retries 43a. The secure booting retries 43a store information representing whether or not a retry of secure booting has been executed using the SPI ROM images of the other controller 10. In the present embodiment, any of “1” representing that a retry has not been performed (not retried), and “2” representing that a retry has been performed (retried) is stored in the secure booting retries 43a.

Next, the recovery management table 44 is explained.

FIG. 5 is a configuration diagram of the recovery management table according to the one embodiment.

The recovery management table 44 is a table that manages information as to whether or not a recovery using the SPI ROM images of the other controller 10 has been performed at the time of activation of the information processing apparatus 1, and various types of information are registered therein by the FPGA 30 at the time of an activation process. For example, the recovery management table 44 stores an entry for each activation process of the information processing apparatus 1. The entries of the recovery management table 44 include fields of dates/times 44a, event IDs 44b, event names 44c, importances 44d, locations 44e, and location IDs 44f.

The dates/times 44a store dates/times of activation. The event IDs 44b store identification information (IDs) of events of activation processes corresponding to the entries. The event names 44c store the names of the events. The importances 44d store information as to whether or not recoveries have been implemented in the activation processes corresponding to the entries. The locations 44e store positions (locations) of target portions of the recoveries. The location IDs 44f store IDs of the locations corresponding to the entries.

Next, a secure activation process (secure booting) of the information processing apparatus 1 is explained.

Here, in the information processing apparatus 1, the SPI ROM images 51 are stored on the SPI ROM 50 in advance, and the e-signature and public key for detecting a falsification of the SPI ROM images 51 is stored on the SPI ROM 40, in order to perform secure booting.

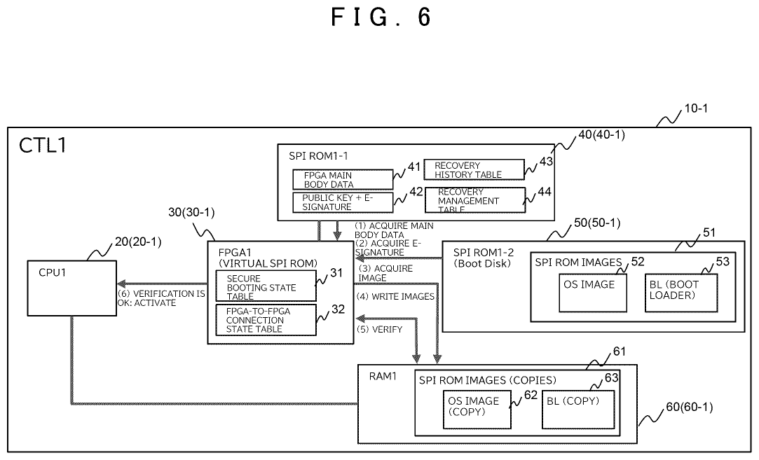

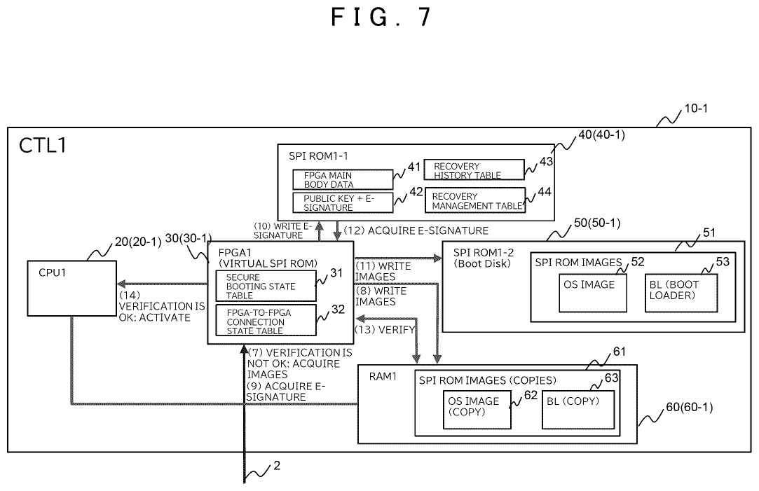

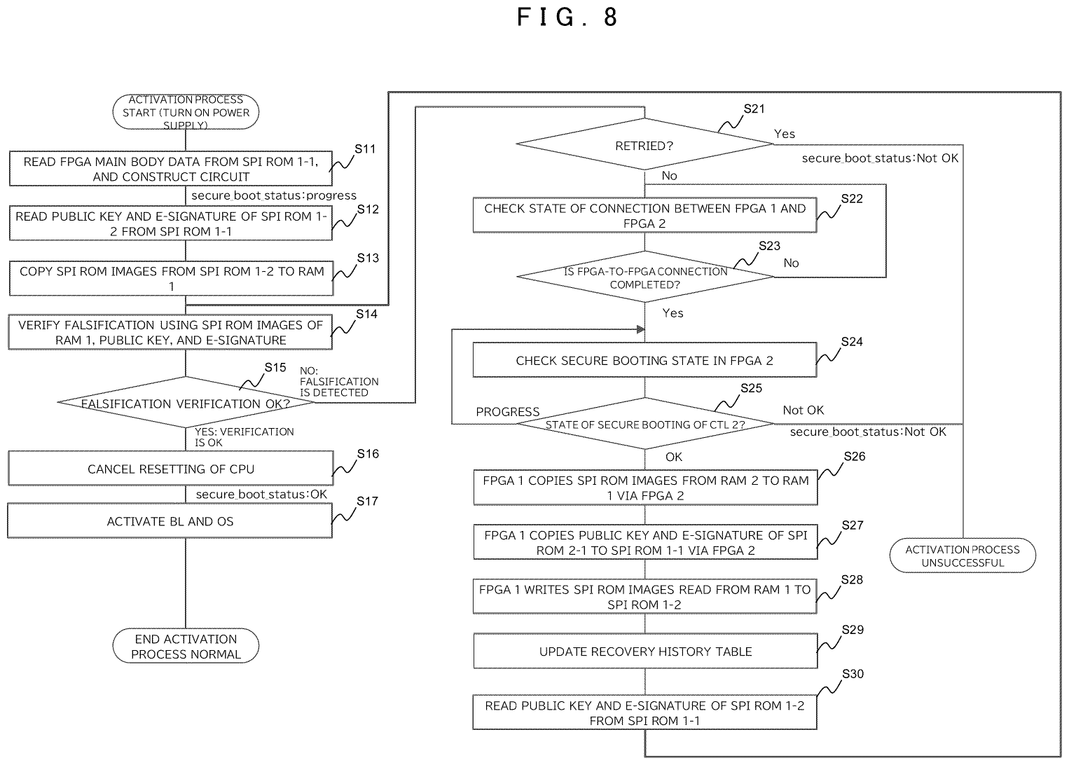

FIG. 6 is a first operation transition diagram of an activation process according to the one embodiment. FIG. 7 is a second operation transition diagram of the activation process according to the one embodiment. FIG. 8 is a flowchart of the activation process according to the one embodiment. Here, FIG. 6 is an operation transition diagram depicting a case where verification of the existing SPI ROM images of an own controller 10 is executed, and the verification is successful, and FIG. 7 is an operation transition diagram depicting a case where the verification of the existing SPI ROM images is unsuccessful. In addition, FIG. 8 is a flowchart of an activation process at the CTL 1, and a similar activation process is performed also at the CTL 2. Specifically, the process is performed with the configuration of the CTL 1 and the configuration of the CTL 2 being replaced with each other.

When the power supply of the information processing apparatus 1 is turned on, the FPGA 1 of the CTL 1 reads the FPGA main body data 41 from the SPI ROM 1-1, and a circuit is constructed inside the CTL 1 on the basis of the FPGA main body data 41 (S11, (1) in FIG. 6). At this time, the FPGA 1 stores, in the secure booting state table 31, information representing that secure booting is being executed (“2” in this example).

Next, the FPGA 1 reads the public key and e-signature 42 from the SPI ROM 1-1 (S12: (2) in FIG. 6).

Next, the FPGA 1 acquires the SPI ROM images 51 from the SPI ROM 1-2 ((3) in FIG. 6), and writes the SPI ROM images 51 in the RAM 1 ((4) in FIG. 6) (S13).

Next, using the SPI ROM images 61 of the RAM 1, the public key, and the e-signature, the FGPA 1 verifies falsification of the SPI ROM images 61 (S14, (5) in FIG. 6).

Where, as a result of the verification of falsification, it is detected that the SPI ROM images 61 are not falsified (verification is OK) (S15: Yes), the FPGA 1 cancels a reset state of the CPU 1, and stores, in the secure booting state table 31, information representing that secure booting is successful (“1” in this example) (S16, (6) in FIG. 6). Thereby, the CPU 1 activates the BL and the OS using the BL 63 and the OS image 62 of the RAM 1 (S17).

In contrast, where, as a result of the verification of falsification, it is detected that the SPI ROM images 61 are falsified (verification is Not OK) (S15: No), the FPGA 1 determines whether or not a retry of secure booting has been performed (a recovery has been implemented) (S21). Specifically, the FPGA 1 makes a determination on the basis of the value of a secure booting retry 43a in the recovery history table 43.

Where, as a result of the determination, that a retry has been performed (S21: Yes), this means that the verification is unsuccessful even in the retry. Accordingly, the FPGA 1 stores, in the secure booting state table 31, information representing that secure booting is unsuccessful (“3” in this example), and the activation process is ended as being unsuccessful.

In contrast, where a retry has not been performed (S21: No), the FPGA 1 refers to the FPGA-to-FPGA connection state table 32 to check the state of connection between the FPGA 1 and the FPGA 2 (S22), and determines whether or not the FPGA-to-FPGA connection has been completed (S23).

Where, as a result of the determination, the connection has not been completed (S23: No), the FPGA 1 proceeds to a process at Step S22.

In contrast, where the connection has been completed (S23: Yes), the FPGA 1 refers to the secure booting state table 31 of the FPGA 2 to check the state of secure booting (S24), and determines which state the secure booting is in (S25).

Where, as a result of the determination, secure booting is being executed (S25: Progress), the FPGA 1 proceeds to a process at Step S24 to wait for a process at the CTL 2.

In addition, where the state of secure booting is an unsuccessful state (S25: Not OK), this means that a result of the verification of falsification does not become OK even if the SPI ROM images of the CTL 2 are used. Accordingly, the FPGA 1 stores, in the secure booting state table 31, information representing that secure booting is unsuccessful (“3” in this example), and the activation process is ended as being unsuccessful.

In addition, where the state of secure booting is a successful state (S25: OK), the FPGA 1 acquires the SPI ROM images 61 from the RAM 2 via the FPGA 2 ((7) in FIG. 7), and writes the acquired SPI ROM images in the RAM 1 ((8) in FIG. 7) (S26). Note that the FPGA 1 may acquire the SPI ROM images 61 from the SPI ROM 2-2.

Next, the FPGA 1 acquires the public key and e-signature from the SPI ROM 2-1 via the FPGA 2 ((9) in FIG. 7), and writes the acquired public key and e-signature in the SPI ROM 1-1 ((10) in FIG. 7) (S27).

Next, the FPGA 1 acquires the SPI ROM images 61 from the RAM 1, and writes the acquired SPI ROM images 61 in the SPI ROM 1-2 ((11) in FIG. 7 (S28)). Next, the FPGA 1 updates the recovery history table 43 such that a secure booting retry 43a represents that a retry has been performed (S29), reads the public key and e-signature (the public key and e-signature written at Step S27) from the SPI ROM 1-1 ((12) in FIG. 7, S30), and proceeds to a process at Step S14).

Thereafter, at Step S14, using the SPI ROM images 61 of the RAM 1 (the SPI ROM images written at Step S26), the public key, and the e-signature, the FPGA 1 verifies falsification of the SPI ROM images 61 ((13) in FIG. 7).

Where, as a result of the verification of falsification, it is detected that the SPI ROM images 61 are not falsified (verification is OK) (S15: Yes), the FPGA 1 cancels the reset state of the CPU 1 (S16, (14) in FIG. 7). Thereby, the CPU 1 activates the BL and the OS using the BL 63 and the OS image 62 of the RAM 1 (S17).

In this manner, according to the activation process according to the present embodiment, where falsification verification of the SPI ROM images 51 stored on the SPI ROM 50 in one controller 10 is unsuccessful, the FPGA 30 acquires the SPI ROM images 51 from another controller 10, and can cause the CPU 20 to further proceed with an activation process of the controller 10 using the SPI ROM images 51. In addition, the public key and e-signature corresponding to the SPI ROM images is acquired from the other controller 10, and the falsification verification is performed. Accordingly, for example, even where the versions of the SPI ROM images being used are different between one controller 10 and another controller 10, the falsification verification can be performed at the one controller 10 appropriately.

Note that the present invention is not limited to the embodiment mentioned above, but can be implemented with modifications being made thereto as appropriate within the scope not departing from the aim of the present invention.

For example, whereas, in the embodiment described above, where the falsification verification at one controller 10 is unsuccessful, the SPI ROM images are acquired from another controller 10, and verification of falsification is performed, the SPI ROM images acquired from the other controller 10 may be used without performing verification of falsification.

In addition, whereas, in the embodiment described above, where the falsification verification at one controller 10 is unsuccessful, the public key and the e-signature are acquired from another controller 10, and verification of falsification is performed using the acquired public key and e-signature, where identical SPI ROM images are used at the one controller 10 and the other controller 10, the public key and the e-signature may not be acquired from the other controller 10, and falsification verification may be performed using the public key and the e-signature of the one controller 10. By doing so, the amount of data transmitted between the one controller 10 and the other controller 10 and processes can be reduced.

What is claimed is:

1. An information processing apparatus having a plurality of control apparatuses, wherein
each of the control apparatuses includes
a processor, a processing circuit, a first storage apparatus, and a second storage apparatus,
the second storage apparatus storing a software image to be executed by the processor,
the first storage apparatus storing an e-signature and a public key for verifying whether or not the software image is falsified,
the processing circuit of each of the control apparatuses
acquires the e-signature and the public key from the first storage apparatus at a time of activation of the information processing apparatus, and
verifies whether or not the software image stored on the second storage apparatus is falsified, and
a first processing circuit of a first control apparatus, the first processing circuit detecting that the software image is falsified,
acquires a software image via a second processing circuit of a second control apparatus having the software image that is detected as being not falsified, and
causes an operation by the processor of the first control apparatus to be started using the acquired software image.

2. The information processing apparatus according to claim 1, wherein
the first processing circuit stores, on the second storage apparatus of the first control apparatus, the software image acquired via the second processing circuit of the second control apparatus.

3. The information processing apparatus according to claim 1, wherein
the first processing circuit
verifies whether or not the software image acquired via the second processing circuit of the second control apparatus is falsified, and,
when it is detected that the software image is not falsified, causes an operation by the processor of the first control apparatus to be started using the acquired software image.

4. The information processing apparatus according to claim 3, wherein
the first processing circuit
acquires, via the second processing circuit, an e-signature and a public key that are stored on the first storage apparatus of the second control apparatus,
verifies whether or not the software image is falsified, using the e-signature and the public key that are acquired via the second processing circuit, and,
when it is detected that the software image is not falsified, causes an operation by the processor of the first control apparatus to be started using the software image.

5. The information processing apparatus according to claim 1, wherein
the first processing circuit and the second processing circuit are directly connected to each other so as to be communicably.

6. The information processing apparatus according to claim 1, wherein
a storage area for the software image in the second storage apparatus of the second control apparatus is an area to which the processor of the first control apparatus is not allowed to access.

7. The information processing apparatus according to claim 1, wherein
the first processing circuit of the first control apparatus, the first processing circuit detecting that the software image is falsified,
waits until verification as to whether or not the software image at the second control apparatus is falsified is ended, and,
when it is detected that the software image is not falsified, acquires the software image via the second processing circuit of the second control apparatus.

8. The information processing apparatus according to claim 1, wherein
the first processing circuit of the first control apparatus, the first processing circuit detecting that the software image is falsified,
stores information representing that an operation by the processor is started using the software image in the second control apparatus.

9. The information processing apparatus according to claim 1, wherein
the processing circuit is a field programmable gate array, and
the first storage apparatus stores data for constructing a circuit of the field programmable gate array.

10. An information processing apparatus activation method by an information processing apparatus having a plurality of control apparatuses,
each of the control apparatuses including a processor, a processing circuit, a first storage apparatus, and a second storage apparatus,
the method comprising:
storing, by the second storage apparatus, a software image to be executed by the processor;
storing, by the first storage apparatus, an e-signature and a public key for verifying whether or not the software image is falsified; and,
by the processing circuit of each of the control apparatuses,
acquiring the e-signature and the public key from the first storage apparatus at a time of activation of the information processing apparatus; and
verifying whether or not the software image stored on the second storage apparatus is falsified; and
by a first processing circuit of a first control apparatus, the first processing circuit detecting that the software image is falsified,
acquiring a software image via a second processing circuit of a second control apparatus having the software image that is detected as being not falsified; and
causing an operation by the processor of the first control apparatus to be started using the acquired software image.
